(19) United States
(12) Patent Application Publication
(10) Pub. No.: US 2026/0101238 A1
(43) Pub. Date: Apr. 9, 2026

(54) EXPOSURE OF AVAILABLE DATA RATES

(71) Applicant: InterDigital Patent Holdings, Inc., Wilmington, DE (US)

(72) Inventors: Achref Methenni, Montreal (CA); Michael Starsinic, Newtown, PA (US); Michel Roy, Candiac (CA); Xavier De Foy, Kirkland (CA); Magurawalage Chathura Madhusanka Sarathchandra, London (GB); Rocco Di Girolamo, Laval (CA); Srinivas Gudumasu, Montreal (CA)

(73) Assignee: InterDigital Patent Holdings, Inc., Wilmington, DE (US)

(21) Appl. No.: 18/905,966

(22) Filed: Oct. 3, 2024

(51) Int. Cl. H04W 28/24; H04W 28/02

(52) U.S. Cl. CPC H04W 28/24; H04W 28/0257; H04W 28/0268

(57) ABSTRACT

Disclosed herein are systems, methods, and instrumentalities associated with estimating and reporting an available data rate (ADR). A network device network device associated with a wireless communication network may determine an ADR associated with a data flow and a time period during which the ADR can be accommodated by the wireless communication network. The ADR may indicate a data rate capability of the wireless communication network with respect to the data flow, and the network device may determine, based at least on the ADR and the time period, whether to report the ADR to at least one other device. If the determination is to report the ADR, the network device may generate and transmit a report to the at least one other device, wherein the report may indicate at least one of the ADR or the time period.

### BACKGROUND

An available data rate may be used for various purposes, such as, for example, determining if a communication network can accommodate a quality of service (QoS) flow. There are, however, challenges associated with exposing or reporting the available data rate, for example, in the context of mobility.

### SUMMARY

Disclosed herein are systems, methods and instrumentalities associated with estimating and reporting an available data rate (ADR). According to embodiments of the present disclosure, a network device network device associated with a wireless communication network may be configured to determine an ADR associated with a data flow and a time period during which the ADR can be accommodated by the wireless communication network, wherein the ADR may indicate a data rate capability of the wireless communication network with respect to the data flow (e.g., for sending or receiving the data flow). The network device may be further configured to determine, based at least on the ADR and the time period, whether to report the ADR to at least one other device. If the determination is to report the ADR, the network device may generate and transmit a report to the at least one other device, wherein the report may indicate at least one of the ADR or the time period.

In examples, the ADR may be greater than a guaranteed flow bit rate associated with the data flow and less than a maximum flow bit rate associated with the data flow. In examples, the network device may be further configured to receive a request for the report.

In examples, the network device may determine whether to report the ADR based further on a first threshold value, and the determination to report the ADR may be made based at least on a condition that the ADR is above the first threshold value. In examples, the network device may determine whether to report the ADR based further on a second threshold value, wherein the determination to report the ADR may be made based on a further condition that a length of the time period exceeds the second threshold value.

In examples, the network device may be further configured to receive ADR reporting assistance information that may indicate at least one of the first threshold value or the second threshold value. In examples, the ADR reporting assistance information may further indicate a granularity for reporting the ADR. In examples, the ADR reporting assistance information may be received from a session management function (SMF) of the wireless communication network, for example, as part of a quality of service (QoS) profile.

In examples, the ADR may be associated with a QoS flow or a service data flow (SDF). In examples, the network device may be a base station of the wireless communication network, which may be further configured to determine at least one of the ADR or the time period based on mobility information of a wireless transmit/receive unit (WTRU) associated with the data flow. In examples, the mobility information may indicate an expected mobile or stationary state of the WTRU.

In examples, the network device may be a user plane function (UPF) of the wireless communication network, and the UPF may be further configured to determine a validity of the report based on a mobility event detected by the UPF. The UPF may then send an indication of the validity of the report to the at least one other device.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of providing an ADR estimate to an application server or function.

FIG. 3 is a diagram illustrating an example of providing an ADR estimate based on WTRU behaviors.

### DETAILED DESCRIPTION

A more detailed understanding can be had from the following description, given by way of example in conjunction with the accompanying drawings.

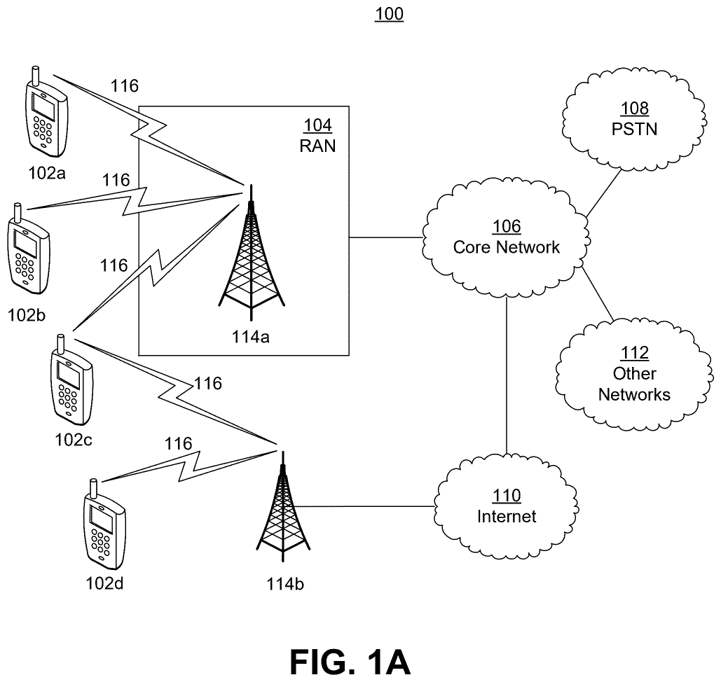

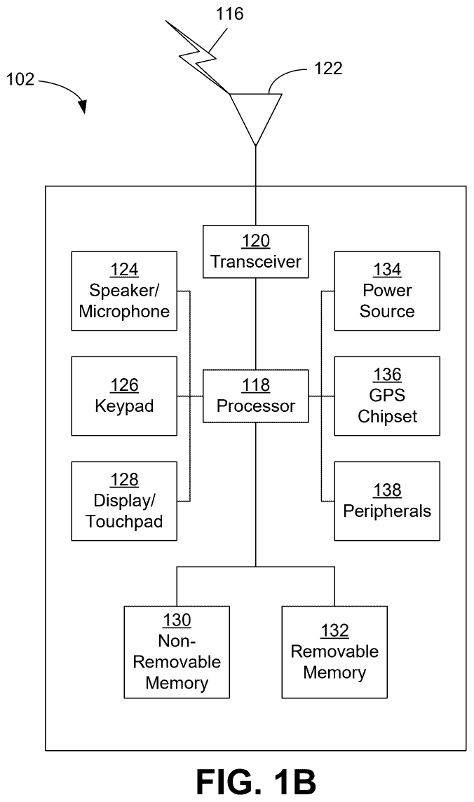

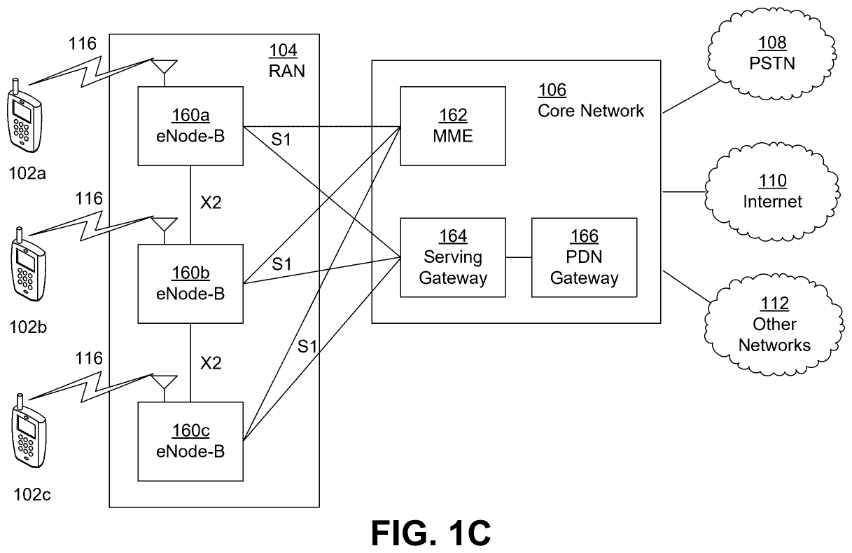

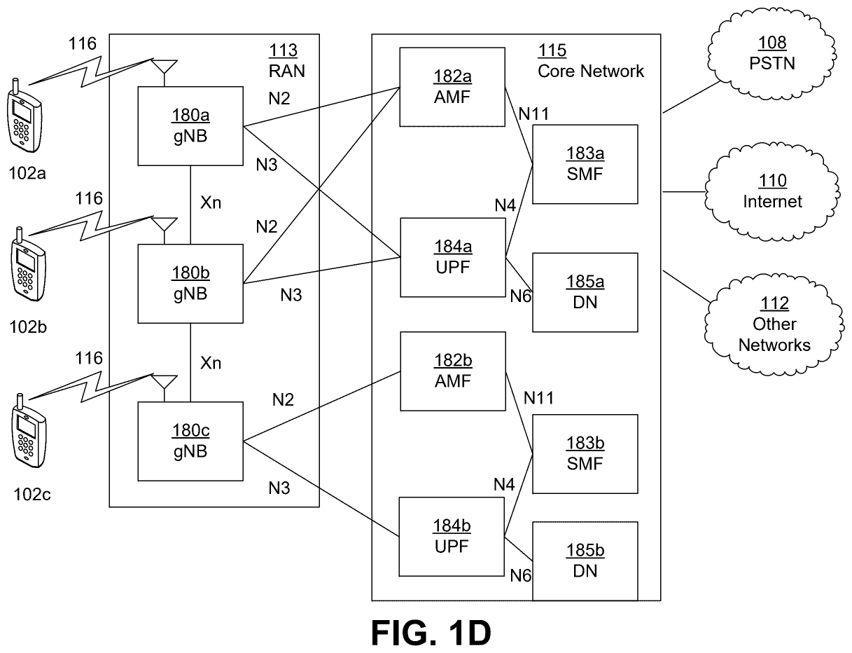

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a WTRU.

The communications systems 100 can include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a base station, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., a eNB and a base station).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b can not be required to access the Internet 110 via the CN 106/115.

The RAN 104/113 can be in communication with the CN 106/115, which can be any type of network configured to provide voice, data, applications, and/or voice over internet protocol (VoIP) services to one or more of the WTRUs 102a, 102b, 102c, 102d. The data can have varying quality of service (QoS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

One or more (e.g., all) of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining consistent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134, and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WTRU 102 can include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining includeent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 160a, 160b, 160c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode cannot have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHz, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include base stations 180a, 180b, 180c, though it will be appreciated that the RAN 113 can include any number of base stations while remaining consistent with an embodiment. The base stations 180a, 180b, 180c can each include one or more transceivers for communicating with the WTRUs 102a, 102b, 102c over the air interface 116. In one embodiment, the base stations 180a, 180b, 180c can implement MIMO technology. For example, base stations 180a, 108b can utilize beamforming to transmit signals to and/or receive signals from the base stations 180a, 180b, 180c. Thus, the base station 180a, for example, can use multiple antennas to transmit wireless signals to, and/or receive wireless signals from, the WTRU 102a. In an embodiment, the base stations 180a, 180b, 180c can implement carrier aggregation technology. For example, the base station 180a can transmit multiple component carriers to the WTRU 102a (not shown). A subset of these component carriers can be on unlicensed spectrum while the remaining component carriers can be on licensed spectrum. In an embodiment, the base stations 180a, 180b, 180c can implement Coordinated Multi-Point (CoMP) technology. For example, WTRU 102a can receive coordinated transmissions from base station 180a and base station 180b (and/or base station 180c).

The WTRUs 102a, 102b, 102c can communicate with base stations 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with base stations 180a, 180b, 180c using subframe or transmission time intervals (TTIs) of various or scalable lengths (e.g., containing varying number of OFDM symbols and/or lasting varying lengths of absolute time).

The base stations 180a, 180b, 180c can be configured to communicate with the WTRUs 102a, 102b, 102c in a standalone configuration and/or a non-standalone configuration. In the standalone configuration, WTRUs 102a, 102b, 102c can communicate with base stations 180a, 180b, 180c without also accessing other RANs (e.g., such as eNode-Bs 160a, 160b, 160c). In the standalone configuration, WTRUs 102a, 102b, 102c can utilize one or more of base stations 180a, 180b, 180c as a mobility anchor point. In the standalone configuration, WTRUs 102a, 102b, 102c can communicate with base stations 180a, 180b, 180c using signals in an unlicensed band. In a non-standalone configuration WTRUs 102a, 102b, 102c can communicate with/connect to base stations 180a, 180b, 180c while also communicating with/connecting to another RAN such as eNode-Bs 160a, 160b, 160c. For example, WTRUs 102a, 102b, 102c can implement DC principles to communicate with one or more base stations 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and base stations 180a, 180b, 180c can provide additional coverage and/or throughput for servicing WTRUs 102a, 102b, 102c.

Each of the base stations 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c can communicate with one another over an Xn interface.

The CN 115 shown in FIG. 1D can include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the base stations 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating WTRU IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the base stations 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can perform testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

An available data rate (ADR) associated with a data flow or a QoS flow may indicate the data rate capability of a network device (e.g., a RAN node) and may be used to determine if the network device can accommodate the data rate requirements associated with the data flow or the QoS flow. For example, if a sender (e.g., an application on a WTRU or an application server (AS)) attempts to send data (e.g., via one or more PDUs) at a rate that is greater than the available data rate, a RAN node may drop or discard at least some of the PDUs transmitted by the sender. If the sender attempts to send data at a rate that is less than or equal to the available data rate, the RAN node may be capable of delivering (e.g., forwarding) all of the PDUs transmitted by the sender. In the case of a guaranteed bit rate (GBR) flow, the available data rate may be greater than or equal to the guaranteed bit rate and less than or equal to a maximum bit rate (MBR).

The terms “RAN,” “RAN node,” “base station,” eNodeB (eNB), and gNodeB (gNB) may be used interchangeably herein. The terms “data flow,” “service data flow (SDF)” and “QoS flow” may also be used interchangeably herein. Also, when referred to herein, a UPF may be an example of a PDU session anchor or a gateway, so the functionality described herein for the UPF may also be performed by any device configured as a PDU session anchor or gateway. A measurement associated with an available data rate may be performed by a network node such as a RAN node. The measurement may be performed to determine an available data rate that the network node (e.g., RAN node) may be able to provide or accommodate for a data or QoS flow over a time period.

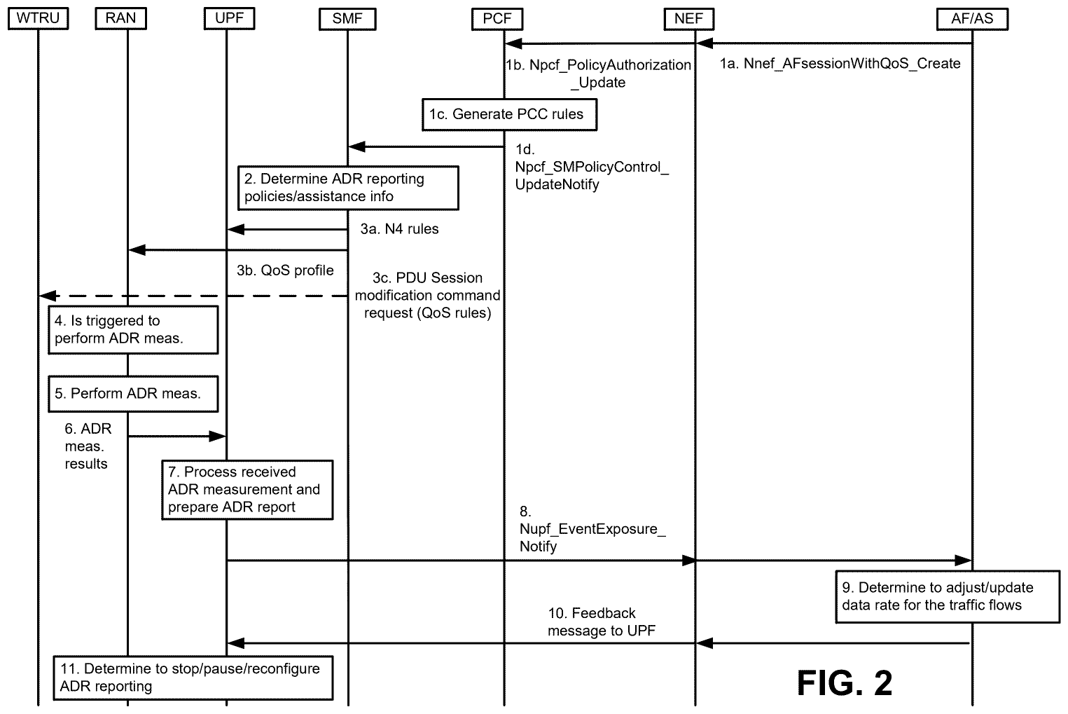

FIG. 2 illustrates example operations that may be performed by various devices of a wireless communication network such as a UPF and a RAN node. For example, as shown in FIG. 2, the UPF may, at 3a of FIG. 2, receive one or more N4 rules (e.g., related to the N4 interface shown in FIG. 1D) and/or ADR reporting assistance information from an SMF. The ADR reporting assistance information may include one or more of the following pieces of information (e.g., for a QoS flow): an indication that ADR reporting is requested, a minimum duration threshold, and/or one or more data rate thresholds. At 7 of FIG. 2, the UPF may receive ADR measurement or estimation results (e.g., from a RAN) and may generate an ADR estimation report based on the ADR measurement results. The UPF may include an estimated (e.g., measured) ADR and/or a time duration indicated by the received ADR measurement results in the ADR estimation report. At 8 of FIG. 2, the UPF may send the ADR estimation report to an AS or an application function (AF). In examples, the UPF may do so on a condition that the aforementioned time duration is greater than the minimum duration threshold indicated by the ADR reporting assistance information, and/or on a condition that the estimated ADR is greater than or equal to one of the one or more data rate thresholds indicated by the ADR reporting assistance information. At 8 of FIG. 2, the UPF may, based on a notification received from an SMF that the RAN associated with the QoS flow has changed, send a notification to the AF that the ADR estimate report may no longer be valid.

Also as shown in FIG. 2, the RAN node (e.g., a base station) may perform one or more of the following actions. At 3b of FIG. 2, the RAN node may receive a QoS profile and/or ADR reporting assistance information from an SMF. The ADR reporting assistance information may include one or more of the following pieces of information (e.g., for a QoS flow associated with the QoS profile): an indication that ADR reporting is requested, a minimum duration threshold, and/or one or more data rate thresholds. At 4 and 5 of FIG. 2, the RAN node may determine (e.g., measure) an ADR (e.g., for the QoS flow) and/or a time duration in which the ADR may be available. The determination may be made based on WTRU trajectory information that may be indicate a mobile or stationary state of the WTRU, and/or an expected time and/or day of week at which the WTRU may be expected to be mobile or stationary. In examples, the trajectory information may be received from an AMF or an SMF.

At 4, 5, and 6 of FIG. 2, the RAN node may send ADR measurement or estimation results (e.g., via an ADR estimation report) to the UPF. The RAN node may do so on a condition that the determined time duration associated with the measured or estimated ADR is greater than the minimum duration threshold indicated by the ADR reporting assistance information, and/or on a condition that the estimated ARD is greater than or equal to one of the one or more data rate thresholds indicated by the ADR reporting assistance information.

ADR information may be exposed (e.g., reported or otherwise sent) to an AF. One or more QoS rules may be established (e.g., transmitted, stored and/or used) to allow a WTRU to classify uplink traffic, associate the uplink traffic with a specific QoS flow identifier, and/or mark the uplink traffic. The estimation and/or reporting of an ADR may be supported for a GBR QoS flow. The ADR may indicate a data rate that the network (e.g., a RAN node) may be able to provide within a certain time duration.

The AF may request a PCF to expose the ADR (e.g., the request may serve as a request for ADR reporting). The PCF may instruct an SMF to activate ADR reporting and/or exposure (e.g., for a GBR QoS flow). A RAN node may be configured to report the ADR to a UPF (e.g., via a user plane). The ADR may be reported to the AF directly or via an NEF.

The ADR (e.g., as a metric or measurement) may be reported by the RAN node to the UPF. The UPF may expose (e.g., report) the ADR (e.g., for a GBR QoS flow) to the AF (e.g., directly or via the NEF). The ADR may indicate data rate capabilities (e.g., unused data rate capabilities) of the network (e.g., a data rate that may be guaranteed by the RAN) for a time period or duration. The ADR and the time period or duration may be determined by the RAN node.

The AF may use the knowledge about an ADR for different purposes, for example, based on the type of data sent by the AF in a GBR QoS flow and/or based on the duration over which the ADR is available. For example, a high data rate available for 10 seconds may not be beneficial for a video steaming application because it may not improve the quality of experience (QoE) associated with the video. In contrast, a high data rate available for a minute may be beneficial for the same video steaming application because it may improve the QoE of the video.

A RAN node may determine whether ADR reporting may be useful to an application associated with a QoS flow (e.g., a GBR QoS flow). An ADR reporting procedure may provide an AF with information that may help the AF decide if adjusting certain application layer behavior (e.g., changing the data rate) may improve a user's QoE.

ADR reporting may take WTRU mobility into consideration. For example, a WTRU may connect to different RAN nodes and the determination of an ADR at each RAN node may be different. For example, a guaranteed data rate reported by each RAN node may be associated with a different time duration and/or may be influenced by other WTRUs connected to the RAN node. As another example, a RAN node may be part of a first Public Land Mobile Network (PLMN) (e.g., a visitor PLMN or VPLMN) and a UPF may be part of a second PLMN (e.g., a home PLMN or HPLMN). As yet another example, some RAN nodes may not support ADR reporting. As yet another example, the ADR reporting by a RAN node to the UPF may depend on an SLA between the operator of the RAN node (e.g., a VPLMN) and the operator of the UPF (e.g., an HPLMN).

ADR reporting may take user privacy into consideration, for example, when sending information to an AF. For example, the AF may be a third party application server configured to stream data to a WTRU and the AF may not be authorized to track the WTRU's movements. Providing the AF with information about changes regarding which RAN node is serving the WTRU may expose the information to the AF, which may be used by the AF to infer information about the WTRU's location.

A RAN node may be configured to determine when ADR information may be useful to an AF and therefore may be reported. The RAN node may determine the usefulness based on one or more data rate thresholds and/or a minimum duration, for example. The data rate thresholds and/or the minimum duration may depend on the type of data being carried in a flow.

Improvements may be made to provide better (e.g., more accurate) estimates of an ADR. For example, a RAN node may improve the accuracy of ADR estimates by considering expected WTRU behaviors (e.g., an expected trajectory of the WTRU).

A network device may be configured to detect that an ADR estimate has become invalid even if a time duration associated with the ADR (e.g., the time duration described herein) has not expired.

FIG. 2 illustrates an example procedure for reporting ADR estimates to an AF or AS.

At 1a of FIG. 2, the AF may send a request to a communication network (e.g., a 5G core network) to reserve resources for an AF session. For example, the AF may send the request via a Nnef_AFsessionWithQoS_Create service provided by an NEF application programming interface (API). The AF request may be used to provide a IP address for a WTRU that the AS may desire to exchange traffic with. The AF request may provide service description information for a service data flow (SDF) of interest. For example, for an eXtended reality and multimodal service (XRM) application, the AF request may include traffic descriptors for one or more SDFs that may carry different modalities of the XRM traffic. The AF request may include QoS service requirements (e.g., QoS reference values or QoS parameters) for different SDFs of interest. The AF request may include packet filter information such as one or more SDF group IDs.

For one or more of the SDFs of interest, the AF may indicate, via the action at 1a, that the SDF(s) may be carried by a certain QoS flow (e.g., a GBR QoS flow). In such cases, the AF may provide a GBR value and/or a maximum bit rate (MBR) value for each SDF that has a data rate requirement. The AF may provide a maximum burst size and/or a requested packet error rate at 1a. The AF may provide a value for the averaging window of GBR QoS flows, a Packet Delay Budget (PDB) value for an SDF of interest and/or a Packet Error Rate (PER) value for the SDF of interest.

The AF may provide, at 1a, QoS monitoring requirements for monitoring certain parameters related to an SDF of interest. The AF may provide the direction of the SDF of interest (e.g., whether the SDF is for downlink or uplink). The AF may include an indication that ADR reporting may be requested for the SDF of interest. The AF may indicate that an ADR may be measured and reported for some or all the SDFs associated with a type of flows (e.g., GBR type flows).

The AF may include, in the request sent at 1a, one or more ADR measurement attributes. For example, the AF may include a duration value to reflect the minimum duration of the ADR for a traffic flow or a QoS flow of interest. The minimum duration value may reflect the minimum time that the ADR may be available for the AF to consider the ADR useful and for the AF to adjust application layer settings to take advantage of the ADR.

The AF may indicate, at 1a, ADR reporting assistance information. The assistance information may include a reporting period. The assistance information may include a reporting threshold. The reporting threshold may, for example, represent a minimum available data rate threshold, in which case the communication network may report and ADR if it exceeds a certain threshold value. If the ADR decreases before the duration of the ADR expires, the decrease may (e.g., always) be reported to the AF.

The reporting threshold may indicate a minimum duration threshold, in which case the AF may indicate that an ADR may be reported to the AF if (e.g., only if) the ADR may be supported for at least the minimum duration. Such a threshold may be the same as the duration parameter mentioned previously or a different parameter.

So, for a (e.g., each) flow may be configured with ADR reporting, the request from the AF may include ADR reporting assistance information, which in turn may include a flow description (e.g., an IP 4-Tuple and/or a flow direction), an indication that ADR reporting is requested, a minimum duration threshold, and/or one or more data rate thresholds. The minimum duration threshold may indicate the minimum amount of time that an ADR may be available for the AF to consider it useful (e.g., for varying an application layer data rate). The data rate thresholds may represent data rates that may be useful to the AF. For example, it may be useful for the AF to receive a notification that a data rate of 5 Mbps is available, and it may not be useful for the AF to later receive a notification that a data rate of 5.1 Mbps is available. In this example, improvements to the encoding of application layer traffic may result in a data rate of 6 Mbps and therefore, ADRs below 6 Mbps may not be useful to the AF.

Information such as the minimum duration threshold and/or the data rate thresholds may be used by a RAN node, a UPF, and/or an NEF to limit the number of reports that may be sent from the RAN node, the UPF, and/or the NEF. For a GBR flow, the data rate thresholds may be greater than a Guaranteed Flow Bit Rate (GFBR) and less than or equal to a Maximum Flow Bit Rate (MFBR).

Still referring to FIG. 2, at 1b, the NEF may authorize the AF request received at 1a, and may send a request message to a PCF. This request may include the information provided by the AF at 1a. At 1c, the PCF may authorize the request. If the PCF receives service information and/or requirements for multiple SDFs for the AF session, the PCF may generate a PCC rule for each SDF of interest. Based on the AF's request and/or other policies, the PCF may determine that ADR measurement and reporting may be supported for one or more data or QoS flows of interest. The PCF may include an indication to measure and report the available data rate in the PCC rule(s) (e.g., together with ADR reporting policies and/or ADR assistance information). This indication may be a component of the ADR reporting assistance information. The PCF may include the ADR reporting assistance information as a separate set of fields in the PCC rule(s) or as part of the QoS monitoring policies of the PCC rule(s). For example, the PCF may indicate that QoS monitoring may be configured for the QoS flow that may carry the service data flow of interest, and/or that the available data rate is to be monitored and reported as a QoS related aspect.

The ADR reporting assistance information may include an indication of the granularities at which the ADR reporting may be performed. For example, the ADR reporting for data flows with a GBR resource type may be performed at different granularities, for example, per QoS flow, per SDF, per SDF group, etc.

An SDF group may be a collection of SDFs related to a certain application data session that may have similar QoS requirements (e.g., such SDFs may be carried within the same QoS flow since they have similar QoS requirements). Some SDFs may indicate that they share resources with other SDFs in a certain QoS flow or in an SDF group. These SDFs may be associated with each other and form an SDF group. The SDF group may be identified with an SDF group ID.

The ADR reporting may be performed at a per QoS flow level for a GBR QoS flow that may carry the application traffic. In this case, a RAN node may perform an ADR measurement, while either the RAN node or the UPF may report ADR related information for the QoS flow. For example, if a QoS flow has a GFBR of 6 Mbps and an MFBR of 15 Mbps, a measurement of the ADR may be between 6 Mbps and 15 Mbps, and may be available to one or more (e.g., all) SDFs carried within this QoS flow.

The ADR reporting may be performed at a per service data flow level within a QoS flow. For example, if an SDF within the QoS flow has a GBR of 2 Mbps and an MBR of 5 Mbps, an ADR measurement for this SDF may be between 2 Mbps and 5 Mbps.

The ADR reporting may be performed per SDF group (e.g., for a group of SDFs that may be carried within the same QoS flow). For example, for some SDFs among which bandwidth or other resources may be shared, the SDFs may be associated with each other as a group of SDFs within the QoS flow of interest, and an ADR may be measured and reported for the SDF group. SDFs that are carried within the QoS flow but do not share resources or bandwidth with other SDFs may not be included in the ADR reporting for an SDF group. For example, if three SDFs (e.g., SDF1, SDF2, SDF3) are carried within the same QoS flow, with each SDF having a GBR of 2 Mbps and an MBR of 5 Mbps, then the QoS flow that carries these three flows may have QoS parameters GFBR=6 Mbps and MFBR=15 Mbps. If SDF1 and SDF2 are associated (e.g., they share resources), and SDF3 does not share resources with other SDFs within the QoS flow, then the per SDF group ADR measurement (for SDF1 and SDF2) may have a value between 4 Mbps (GBR1+GBR2) and 10 Mbps (MBR1+MBR2), while the per SDF ADR measurement for SDF3 may be between 2 Mbps and 5 Mbps.

Based on information provided by the AF, the PCF may include, in the PCC rule(s) of one or more SDFs, an indication of whether resource sharing may be authorized and supported for an SDF. In this case, the SMF may use this indication to determine ADR reporting parameters.

The PCF may determine that more than one SDF group may be configured with ADR reporting (e.g., SDF1 and SDF2 share resources in a first SDF group ID1, SDF4 and SDF5 share resources in a second SDF group ID2, while all these SDFs are carried within the same QoS flow). The PCF may determine, based on an application ID or an indication that certain data flows are of a GBR type, that ADR reporting may be supported for multiple (e.g., all) GBR type data flows for this application ID.

The PCC rule(s) may include an indication of the granularities at which ADR reporting may be configured. For example, for a service data flow that carries pose information or haptic feedback from a WTRU to an AS in the uplink direction, per SDF ADR reporting may be enabled since the uplink traffic relates to XRM data traffic and may be the only or main data for an XRM application in the uplink. For service data flows that carry video and audio traffic from the AS to the WTRU in the downlink direction, per SDF group or per QoS flow level ADR reporting may be enabled since the video and audio SDFs may have similar QoS requirements and/or may be transmitted using the same IP 4-tuple.

The PCC rule(s) may indicate, for a (e.g., each) supported ADR reporting granularity, the parameters that may be measured for the ADR reporting. The PCC rule(s) may indicate that the ADR that may be measured. The PCC rule(s) may indicate that a duration parameter may be measured, which may reflect the duration over which the available data rate can be satisfied or maintained. The PCF may include, in the PCC rule(s), an attribute that may reflect a measurement accuracy for the ADR reporting. For example, the PCC rule(s) may indicate that an ADR measurement may be accurate up to an error margin of 0.1 Mbps.

An ADR report may indicate that an available data rate has a value that is within a certain range. For example, the ADR report may indicate that the ADR is between 5.5 Mbps and 6.5 Mbps. In this case, the ADR report may indicate that the ADR is 6 Mbps with an error margin of 0.5 Mbps. A smaller the range may be associated with a more accurate ADR estimate.

The PCF may include in the PCC rule(s) an attribute related to the validity period of ADR related measurements. For example, the PCF may indicate that an ADR measurement may be reliable during the validity period and may no longer be reliable after the validity period expires.

The PCF may determine one or more measurement parameters. These measurement parameters may include a measurement period that may indicate the desired ADR measurement periodicity. For example, the measurement period may indicate a desired time period (T) within which an ADR may be measured. A PCC rule may indicate that an ADR may be measured periodically (e.g., every 5 seconds). A time period T of value 0 may indicate that the ADR measurement may be performed only once, e.g., based on a request or when a certain triggering event is detected. For example, the AF may send a request to the UPF to perform ADR reporting (e.g., a one-time reporting) via a UPF event exposure service. As another example, if a congestion event or a WTRU mobility event is detected, the ADR may be estimated and reported. The PCF may include in the PCC rule(s) an indication of the type of events that may trigger ADR reporting (e.g., trigger event type=“WTRU is moving”). The PCF may determine a start time and a stop time for when the ADR may be measured. The PCF may indicate in the PCC(s) that periodic ADR measurements may be performed and/or that the periodicity of ADR measurements may be determined by a RAN node.

The PCF may include in the PCC rule(s) the direction for which ADR measurements may be performed (e.g., for the uplink direction or the downlink direction). The PCF may determine the direction based on a flow description (e.g., a packet filter set) provided by the AF.

The PCC rules may include triggers or conditions for when ADR reporting may be reassessed or reevaluated. A first trigger may be an event associated with the activation of a PCC rule bound to the QoS flow of interest. This event may occur when a service data flow is setup to be carried in the QoS flow of interest (e.g., which may be referred to as QoS flow1). The activation of the PCC rule may incur an update of one or more QoS flow GBR parameters. For example, if an SDF (e.g., SDF4) is associated with GBR4 and MBR4, then the QoS flow1 GBR parameters may be modified as follows: new GFBR=old GFBR+GBR4, and new MFBR=old MFBR+MBR4. For example, for a QoS flow with GFBR=6 Mbps and MFBR=15 Mbps, if a PCC rule of SDF4 (e.g., with GBR of 2 Mbps and MBR of 5 Mbps) is activated and bound to QoS flow1, then a new GFBR may be set to 8 Mbps, and a new MFBR may be set to 20 Mbps.

A second trigger may be an event associated with the deactivation or modification of an existing PCC rule bound to QoS flow1, which may incur an update to the GFBR and/or MFBR of QoS flow1. For example, the SMF may determine, based on a PCF configuration, that a GFBR and/or an MFBR may be updated, and that ADR measurement/reporting may be reassessed as a result. For instance, if a PCC rule corresponding to SDF4 is activated, the SMF may determine that ADR reporting parameters may be reassessed and/or that per SDF ADR reporting may be configured for SDF4. As another example, if a group of three SDFs each having GBR=2 Mbps share the same resources in a QoS flow, then the GBR of the SDF group may be 6 Mbps. If an SDF (e.g., SDF3) is removed from the SDF group, ADR reporting may be reevaluated or updated.

In examples, if a trigger for ADR reporting reassessment occurs, the SMF may instruct the RAN or the UPF to stop or pause ADR reporting, for example, until new ADR reporting parameters or configurations are selected. In examples, if a trigger for ADR reporting reassessment occurs, the SMF may decide to keep the ADR reporting active for some granularities and pause it for other granularities. For instance, the SMF may decide to pause the per QoS flow ADR reporting (e.g., until QoS flow and/or ADR parameters are updated), but keep the per SDF ADR reporting active for the SDFs within the QoS flow that may not share resources with other SDFs.

In examples, if the PCC rules activation, modification or deactivation impacts only the downlink direction and not the uplink direction, the SMF may determine to pause or stop ADR reporting for the downlink, and keep the ADR reporting active for the uplink.

The PCF may indicate in the PCC rule(s) a timer value that may indicate when to stop or pause ADR reporting (e.g., the timer value may be provided along with triggers or conditions to stop or pause the ADR reporting). The PCF may indicate in the PCC rule(s) that ADR reporting may be paused or deactivated if a congestion event is detected, for example, by a RAN node). The RAN node may be provided with a timer value. The RAN node may use the timer value to decide how long to wait after pausing or stopping ADR reporting (e.g., after a congestion related event is detected) before the ADR reporting may be resumed.

Another trigger for reevaluating ADR measurements may the following. If a network device such as the UPF provides the AF with an ADR measurement, the AF may use the available data rate for one SDF or multiple SDFs. The AF may use a portion of the ADR and not the full ADR value. Resources associated with the ADR may become unavailable when the AF uses the resources for the SDFs of interest. For example, if an network entity (e.g., RAN or UPF) detects that the available data rate that was reported to the AF was used fully or partially by the AF, the network entity may determine that the available data rate resources may no longer be available. This may trigger one or more network entities such as the SMF or the UPF to pause the ADR reporting for a period of time (e.g., the duration in which the available data rate may be used by the AS, which may be provided by the application service as feedback information). The SMF or UPF may determine to reset ADR measurement counters/timers related to the ADR measurement. In this scenario, the SMF or UPF may expect a feedback message from the AS on the data rate that the AS and/or a WTRU may use from the provided ADR measurement, and/or the duration in which the AS expects the data rate to be used.

When the RAN or the UPF sends an ADR report, for example, to an AF and/or for an SDF group, the network associated with the RAN or the UPF may expect the AF to decide how to use the available data rate on the different SDFs of the SDF group. For example, if the UPF sends an ADR report to the AF stating that the available data rate is 12 Mbps for three SDFs of the SDF group, the AF may decide to split the ADR equally among the SDFs, and the data rate used for each SDF may be 12/3=4 Mbps. As another example, the AF may set up more resources (hence a higher data rate) to the SDF that carries video traffic, and less resources (hence a lower data rate) for the SDF that carries audio traffic (both types of traffic may be carried within the same QoS flow). For example, the data rate for a video SDF may be 10 Mbps, and the data rate for an audio SDF may be 2 Mbps. The AF may decide not to use the full ADR of 12 Mbps, and only use 10 Mbps (e.g., 8 Mbps for video traffic and 2 Mbps for the audio traffic).

The PCC rule(s) described herein may include conditions and parameters for reporting ADR related measurements. The PCF may determine, based on information obtained from the AF, threshold value(s) to use for reporting an ADR. A notification may be sent if (e.g., only if) a measured ADR is above a certain threshold value (e.g., ADRTh). In this case, the RAN and/or the UPF may report that a desired ADR is available and can be supported. The RAN and/or the UPF may further determine a duration (e.g., Dur) over which the ADR can be supported or satisfied.

The PCF may determine, based on a duration value obtained from the AF, a duration threshold that may reflect the minimum time during which a desired available data rate may be satisfied. This minimum duration value may be referred to as DurTh. For example, a PCC rule may indicate that a notification may be sent if (e.g., only if a measured ADR is above 5 Mbps (ADRTh=5 Mbps) and can be supported for at least 30 seconds (DurTh=30 seconds)). The PCC rule may indicate that the ADR and duration measurements may be included in an ADR report.

An ADR report may include a notification that the ADR is above a certain threshold (ADRTh). The ADR report may include the ADR measurement determined by a RAN node. The ADR report may include a notification that the desired ADR can be satisfied for a time period longer than a minimum duration threshold (DurTh). The ADR report may include a measurement of the time period (Dur) over which the ADR can be satisfied.

The PCF may use the threshold values described herein to determine ADR measurement parameters such as, e.g., a measurement period. For example, if the minimum duration that a communication network may support a certain ADR value is 10 seconds, then the PCF may determine that a measurement period of 5 seconds may be used in order to have a more granular estimate of the duration over which the ADR can be supported (the Dur attribute described herein).

The PCF may determine, based on information provided by the AF, that multiple values for the ADR threshold, ADRTh, and/or their corresponding duration threshold values, DurTh. For example, the PCF may determine that ADR reporting may be performed if a measured ADR is above ADRTh1=10 Mbps and can be supported for at least DurTh1=10 seconds. The PCF may determine that a notification, an ADR measurement, and/or a duration associated with the ADR measurement may be sent if the measured ADR is above ADRTh2=5 Mbps and can be supported for at least DurTh2=30 seconds.

The PCF may leverage traffic characteristics in the uplink (UL) and/or the downlink (DL) to decide when and/or how to send an ADR report to the AF. For example, an application may send pose information in the UL to the AF, and it may be expected, based on media traffic in the DL (e.g., video, audio, haptic, etc.), that the AF may want to get the ADR information of DL QoS flows and/or SDFs so as to send media traffic correlated to the pose information on the DL. In these situations, ADR information associated with the DL may be added to or sent with an ADR report for UL traffic related to the pose information. This may allow the AF to receive ADR information of the DL ahead of time, with a trigger for sending DL traffic.

It should be noted that even though the PCF has been described as the entity that may determine ADR reporting policies, the ADR reporting policies may also be determined by the SMF.

Still referring to FIG. 2, at 1d, the PCF may send one or more PCC rules to the SMF (e.g., the PCC rule(s) may include ADR reporting assistance information). At 2, the SMF may use the received PCC rules to generate one or more N4 rules for the UPF, a QoS profile for a RAN node, and/or one or more QoS rules for a WTRU. Based on the received PCC rules, the SMF may determine that ADR reporting may be supported and/or set up for an SDF of interest. The SMF may determine an ADR reporting granularity (e.g., per QoS flow, per SDF, or per group of SDF group). The SMF may determine one or more parameters that may be included in an ADR report (e.g., ADR, ADR duration, ADR measurement period, etc.). The SMF may determine ADR reporting reassessment conditions and/or ADR reporting configuration parameters (e.g., ADR thresholds, minimum duration thresholds, etc.). The SMF may determine that a RAN node may perform the ADR measurement and reporting, in which case the SMF may include information (e.g., based on ADR reporting assistance information) in the QoS profile to help configure the RAN node.

The QoS profile may include one or more QoS Flow Identifier (QFI) values and/or one or more QoS parameters (e.g., such as GFBR and MFBR values). The QoS profile may indicate, for a QoS flow of interest, that ADR reporting may be supported and/or measurement/reporting parameters associated with the ADR reporting. The QoS profile may include conditions or triggers to activate, deactivate or pause the ADR reporting. For example, the QoS profile may indicate that ADR reporting may be paused or deactivated if there is a congestion at the RAN level. In that case, if the RAN node is no longer congested, the ADR reporting may be resumed.

The QoS profile may indicate that ADR reporting may be activated if an SDF such as a video traffic SDF is being set up for an AF session and may be carried within a PDU session. The video traffic may vary dynamically, and this may trigger the RAN to activate ADR reporting (e.g., so as to provide a more accurate data rate information to the AF).

The QoS profile may indicate the direction (e.g., UL or DL) for which ADR reporting may be supported. The QoS profile may include one or more ADR threshold values (ADRTh) and/or one or more minimum duration threshold values (DurTh).

In examples, the SMF may determine that a RAN node may perform ADR measurements and the UPF may perform ADR reporting. For example, the UPF may receive the ADR measurements from the RAN, filter the measurements, and prepare an ADR report to send to the AF. In this scenario, ADR measurement parameters may be included in the QoS profile sent to the RAN node, while ADR reporting parameters may be included in the N4 rules sent to the UPF.

At 3a of FIG. 2, the SMF may send the N4 rules to the UPF and may include ADR reporting assistance information in the rules. As shown by 3b, the SMF may also send the QoS profile to the RAN node and may include the ADR reporting assistance information in the QoS profile. At 3c, the SMF may send QoS rules to the WTRU, e.g., via a PDU session modification command message.

At 4, the RAN node may be triggered to start ADR measurement and reporting. For example, the RAN node may be triggered to start the ADR measurement and reporting upon receiving a request from the SMF (e.g., the request from step 3 sent to the RAN node). As another example, the RAN node may start an ADR periodic measurement timer based on the request received at 3, and may be triggered to start the ADR measurement and reporting based on the expiration of the periodic measurement timer.

In examples, the UPF may determine, based on a request from the SMF or based on other triggers such as traffic detection, that ADR reporting may be started. In this case, the UPF may send a notification to the RAN node to indicate that the ADR reporting may start for an SDF or QoS flow of interest.

At 5, the RAN node may perform the ADR measurements, for example, according to the parameters included in the QoS profile. The RAN node may measure the available data rate and the duration in which the measured data rate can be maintained or satisfied. The RAN node may use the threshold values described herein (e.g., ADRTh and/or DurTh) to determine whether the ADR is above a given threshold and/or can be satisfied for at least a duration threshold. The RAN node may prepare a report based on the ADR measurement. The RAN may include a notification that the measured ADR is above a certain ADRTh threshold and/or can be satisfied for a time period that is above a certain DurTh. The RAN may include the ADR measurements and/or the Dur in the ADR report. The RAN may indicate an accuracy level for the ADR measurements and/or a validity period for when the measurements may remain valid.

The UPF may determine the reliability or accuracy of the ADR report based on a WTRU mobility status (e.g., whether the WTRU is stationary or mobile, or whether the WTRU is at a large distance from the RAN node).

At 6, the RAN node may send the ADR report (e.g., including ADR measurement results) to the UPF. The RAN node may send the measurement report via one or more PDUs that may be encapsulated using GTP-U. The GTP-U header may indicate that the PDU(s) may be related to ADR reporting.

At 7, the UPF may process the information received from the RAN node. For example, the UPF may receive the ADR report from the RAN node in one or more GTP-U packets and may determine, based on the GTP-U header, that the packets (e.g., PDUs) may be related to ADR reporting. The UPF may decapsulate the packets and obtain the ADR report. In examples, the UPF may forward the ADR report to the AF. In examples, the UPF may create a report based on the ADR report received from the RAN node and send that report to the AF.

If the ADR measurement performed by the RAN node is related to a specific SDF (e.g., a per SDF ADR measurement was performed), the UPF may send (e.g., as part of the ADR report to the AF) packet filter information related to the SDF, an SDF group ID, and/or an identifier related to the QoS flow. The information reported by the UPF in the ADR report may include an available data rate, a duration, and/or a WTRU identifier (or a subscription identifier that may be correlated to the WTRU identifier).

If the UPF detects that the RAN node serving the WTRU may be changing (e.g., based on GTP tunnel information provided by the SMF), the UPF may send a message or a report to the AF to indicate that previously provided ADR report(s) may become invalid. The message or report may include a cause code that may indicate that the previously provided ADR reports may have become invalid because the RAN node serving the WTRU has changed. The cause code may also indicate that the previously provided ADR report(s) may be considered invalid because the UPF has received an indication that the RAN (or cell) serving the WTRU may have changed. The UPF may indicate that the previously provided ADR report(s) may be considered invalid by providing a new ADR report.

The UPF may receive an indication from the RAN or the SMF that a RAN node may support ADR reporting. If the UPF does not receive a ADR support indication from the RAN or the SMF, the UPF may determine that the RAN does not support ADR reporting. The UPF may receive an indication from the RAN or the SMF that a RAN node currently serving the WTRU may not support ADR reporting.

If the UPF determines or detects that the RAN node currently serving the WTRU does not support ADR reporting, the UPF may send a report (e.g., to the AF) indicating that ADR reporting may not be available for the WTRU. Such a report may include the WTRU identifier or a subscription identifier that may be correlated to the WTRU identifier. The report may include a cause code that may indicate that the RAN node currently serving the WTRU does not support ADR reporting.

At 8 of FIG. 2, the AF may receive the ADR report from the UPF. The UPF may send the ADR report in the user plane (e.g., using a Multiplexed Application Substrate over QUIC Encryption (MASQUE) tunnel between the UPF and the AF). The ADR report provided to the AF may include an event ID (e.g., indicative of the event being reported). The ADR report provided to the AF may include a transaction ID, which may reflect the AF session that the ADR report may be associated with. The transaction ID may have been provided to the AF during AF session setup, e.g., when the NEF sends a response message to the AF. The ADR report may include an application ID, an AF ID, and/or a WTRU ID to which the ADR report may correspond. The AF may use the WTRU ID, application ID, and/or transaction ID to determine the AF session that the ADR report may be associated with.

The ADR report received by the AF may be forwarded by the NEF. The NEF may receive the report from the UPF and, before forwarding the report, the NEF may determine to modify some of the content of the report before forwarding it to the AF. The NEF may decide to modify the content of the report in order to protect the privacy of a user of the WTRU. For example, the UPF may report to the NEF that an available date rate changed because the RAN node serving the WTRU changed. The NEF may report to the AF that the available data rate changed, but may or may not report a cause value to the AF. In the latter case, the AF may not know that the WTRU may be mobile.

At 9 of FIG. 2, the AF may use the information received from the UPF (e.g., through the NEF) to adjust/update the data rate for one or more SDFs. For example, based on information that the ADR for a QoS flow or an SDF group is 12 Mbps and can be satisfied for 1 minute, the AF may increase a video compression ratio to produce a data rate of 10 Mbps for a first SDF, and set an audio compression ratio to produce a data rate of 2 Mbps for a second SDF. The AF may indicate that such compression ratios may be valid for a certain duration before returning to a nominal compression value.

At 10 of FIG. 2, the AF may send a confirmation or feedback message to the UPF to indicate the data rate and/or a duration value associated with the data rate that the AF may have selected/chosen to use (e.g., the data rate selected by the AF may be less or equal than the ADR indicated in the ADR report from the UPF).

At 11 of FIG. 2, the UPF may, based on the feedback message from the AF, request to pause ADR measurement and reporting, e.g., for the duration indicated by the parameter Dur described herein. During this cause period, the AF/AS may exchange traffic with the WTRU, since the data rate selected by the AF may be used for the duration.

The UPF and/or the RAN may use the information included in the feedback message to perform available data rate planning. For example, if the RAN offers 10 Mbps of available bandwidth for 1 minute to the AF and the AF indicates in the feedback message that it intends to use 8 Mbps for 1 minute, the UPF and/or the RAN may take the 8 Mbps used by the AF into consideration when managing the ADR offered to other ADR consumers (e.g., WTRUs).

The AF may have flexibility in selecting the available data rate and/or corresponding duration for an SDF of interest. The AF may include multiple threshold values for the available data rate and/or the duration. For example, the AF may indicate that the RAN and/or the UPF may notify the AF about the ADR if a measured ADR is above a first threshold ADR1=10 Mbps and can be maintained for at least a duration Dur1=30 seconds. The AF may also indicate that, if the first combination of ADR and duration (e.g., ADR1 and Dur1) cannot be satisfied, the RAN and/or the UPF may notify the AF if a measured ADR is above ADR2=5 Mbps and can be maintained for a duration Dur2=75 seconds (e.g., a longer duration than Dur1).

The RAN and/or the UPF may include, in the ADR report, one or more ADR measurements together with the respective durations in which the ADRs may be maintained. The RAN and/or the UPF may include, in the ADR report, an index for each combination of measured ADR and corresponding duration. The AF may send, in the feedback message described herein (e.g., to the UPF), an index value of the combination of ADR and duration that the AF may have decided to use for a traffic flow of interest.

As shown in FIG. 2, the AF may use an NEF API such as Nnef_AFsessionWithQoS_Create to request a communication network to reserve resources for an AF session and/or to request that ADR reporting be set up for one or more SDFs of interest (e.g., the request may include a traffic description, service requirements such as QoS parameters, etc.). Also as shown in FIG. 2, the NEF may send the request of the AF to the PCF. Once the PCF authorizes the AF request, the PCF may generate one or more PCC rules that may include ADR reporting parameters. The PCF may send the PCC rules to the SMF, which may generate corresponding N4 rules for the UPF, and/or a QoS profile for the RAN.

In examples, ADR reporting may be configured and/or performed by subscribing to event exposure at the UPF. In these examples, the AF may or may not invoke the NEF API described above (e.g., Nnef_AFsessionWithQoS_Create) to provide service requirements for one or more SDFs of interest. The AF may subscribe to UPF event exposure via the SMF, for example, by directly interacting with the SMF or through the NEF.

In a first step or operation, the AF may send a request to the NEF to subscribe to event notifications for ADR reporting (e.g., this may be done using an Nnef_EventExposure_Subscribe service operation). The AF may include in the request an indication to subscribe to event exposure from the UPF related to ADR reporting from the UPF. The AF may also subscribe to event exposure related to the ADR in a PDU session that may carry application traffic between a certain WTRU and the AF. The AF may include, in the request, a WTRU identifier and/or service description information such as an IP 4-tuple to identify the SDFs for which ADR reporting may be requested.

The AF may include, in the request, parameters related to the ADR reporting event. The parameters may include a period value that may indicate when the ADR reporting may be periodic, how often an ADR report may be generated and sent to the AF, etc. The parameters may include one or more threshold values related to the ADR reporting. For example, the AF may include a minimum ADR value above which the UPF may send a notification and/or an ADR report to the AF. The parameters may also include a minimum duration value associated with the minimum ADR value. Such a minimum duration value may represent the shortest duration over which the ADR value (e.g., which may be above the ADR threshold) may be maintained or satisfied for the AF to use the ADR and/or to expect a notification from the UPF.

In a second step or operation, the NEF may authorize the AF's request to ADR event exposure. The NEF may determine the PDU session of interest that may carry an application traffic of interest. The NEF may determine the SMF serving the WTRU for the application traffic of interest.

Once the NEF is able to determine the serving SMF, the NEF may send the AF's request for ADR reporting event exposure to the SMF (e.g., together with the event exposure parameters provided by the AF in the first step). The SMF may authorize the request to the UPF and may use the ADR measurement and/or reporting parameters provided by the NEF to determine ADR measurement and/or reporting parameters to provide to the UPF. The SMF may determine the PDU session ID for the PDU session for which the ADR reporting may be configured. The SMF may send a request to the UPF to subscribe to its ADR reporting event exposure. The SMF may include the determined ADR measurement and/or reporting parameters to the UPF via the request.

The SMF may generate or update the QoS profile related to the QoS flow that may be subject to ADR measurement and/or reporting. The QoS profile may include a QFI value of the QoS flow of interest. The QoS profile may include an indication that ADR measurement and reporting may be supported for the QoS flow of interest. The QoS profile may include one or more ADR measurement parameters, such as a measurement period, and/or one or more ADR reporting parameters, such as an ADR threshold or an duration threshold (indicating a minimum duration). The SMF may send the QoS profile to the RAN node.

In the ADR reporting event exposure subscription sent to the UPF, the SMF may indicate that the UPF may expect to receive ADR measurements from the RAN and/or how often the UPF may expect the ADR measurements from the RAN. The SMF may specify a minimum number of samples or measurements that the UPF may obtain to ensure the accuracy of the RAN measurements. The SMF may indicate (e.g., as reporting parameters for the UPF to use) one or more threshold values for the ADR and the duration over which the ADR can be maintained or satisfied.

The RAN may perform ADR measurements, determine an ADR and/or its associated duration, and send the ADR and/or duration to the UPF. The UPF may determine the reliability or accuracy of the ADR measurements performed by the RAN (e.g., by averaging the ADR measurements received over a short period of time, or based on an accuracy indication from the RAN itself). The UPF may use the threshold values described herein to determine whether to send a notification to the AF related to the ADR. The UPF may determine the reliability or accuracy of the ADR measurements based on the mobility status of a WTRU associated with the ADR measurements (e.g., whether the WTRU is stationary or mobile, whether the WTRU is at a large distance from the RAN node, etc.). The UPF may send an ADR report to the AF, for example, using Nupf_EventExposure_Notify service.

The RAN may use WTRU mobility related information to determine an ADR. The ADR may be an estimate of what data rate the AF may assume to be available over a time duration. The accuracy of this estimate may be dependent on the cell that is serving the WTRU. For example, the RAN may determine an accurate estimate of the data rate that may be available to the WTRU over a time duration based on knowledge about where the WTRU may likely be (e.g., the location of the WTRU) over the time duration.

If the WTRU is exchanging data traffic with an AS via a PSA UPF, and the WTRU may be moving, the ADR estimation for the SDF or QoS flow that may carry the application traffic may consider information about the WTRU's mobility. For example, the WTRU may not have the same available data rate when it is moving out of a serving RAN node than when it is moving to a different RAN node. For example, the WTRU may move into an area that may be different than the area the WTRU is expected to move into, according to expected WTRU mobility parameters (e.g., due to an unexpected movement of the WTRU). If the WTRU moves to a different RAN node before the ADR duration estimated by the serving RAN node expires, the ADR duration (e.g., minimum ADR duration) provided by the serving RAN node may not be accurate.

A RAN node may obtain information related to WTRU mobility and may use the information to provide more accurate ADR estimate for application traffic related to the WTRU. The RAN node may also be able to provide the ADR estimate over a longer duration.

An AF may provide expected WTRU behavior parameters for a WTRU. Such expected WTRU behavior parameters may be stored in the WTRU's subscription and sent to an AMF. The expected WTRU behavior parameters may include an expected WTRU moving trajectory, a stationary indication, and/or an expected time and day of week associated with the trajectory (e.g., at what time/day of the week the WTRU may be mobile or stationary).

If the RAN node receives a request to provide an estimate of ADR for a WTRU, the RAN node may send a request to the AMF to obtain the expected WTRU behavior parameters for the WTRU. If the SMF sends a QoS profile to the RAN node to configure an ADR monitoring event, the SMF may retrieve the expected WTRU behavior parameters for the WTRU from a Unified Data Management (UDM) or a Unified Data Repository (UDR) device, and may send the parameters to the RAN node (e.g., in or with the QoS profile).

The RAN node may use the expected WTRU behavior parameters to determine an ADR estimate and a duration associated with the ADR estimate. For example, the RAN node may determine an ADR estimate for the WTRU under the assumption that the cell serving the WTRU may not change. The RAN node may set the duration associated with the estimate such that the duration may expire at a time before the WTRU (e.g., based on the WTRU's trajectory) is likely to move to a different serving cell. For example, the RAN node may determine an ADR estimate for the WTRU under the assumption that the cell serving the WTRU may not change, and the RAN node may set the ADR duration to a relatively long time period if the expected WTRU behavior parameters indicate that the WTRU may be stationary. The RAN node may send an indication to the UPF that the ADR estimate may be valid until the RAN node notifies the UPF that the estimate is no longer valid.

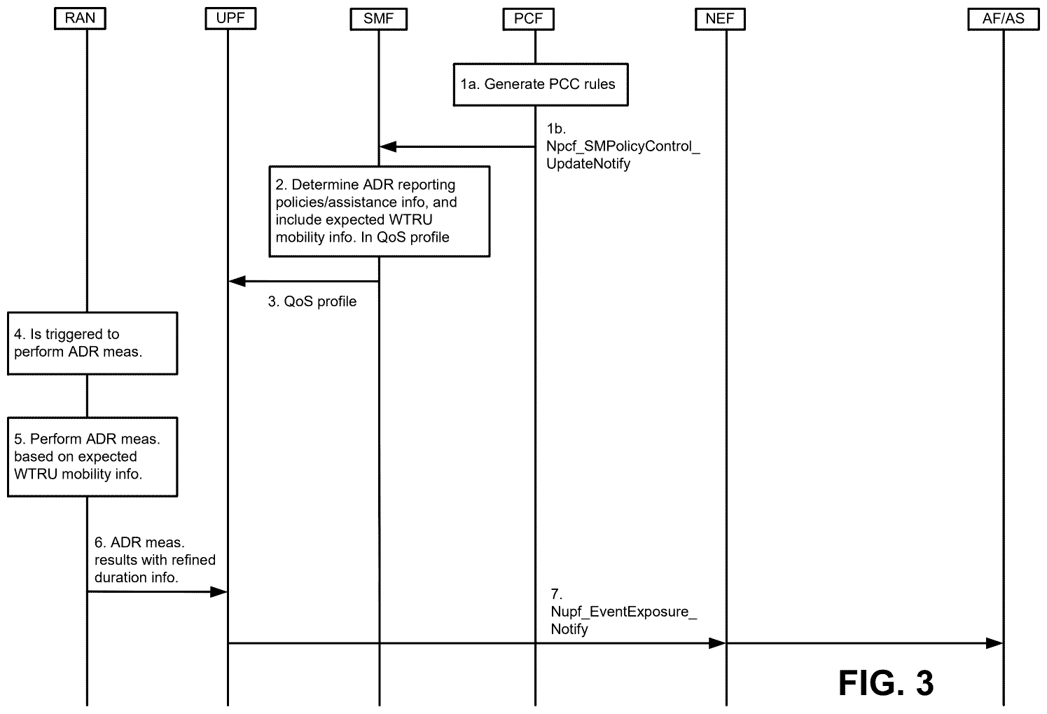

FIG. 3 illustrates an example of how a RAN node may measure and/or report an ADR based on expected WTRU behaviors.

At 1a of FIG. 3, a PCF may generate one or more PCC rules that may indicate or include ADR reporting policies, ADR reporting assistance information, and/or expected WTRU mobility behaviors. At 1b of FIG. 3, an SMF may receive the PCC rules generated by the PCF. These PCC rules may be related to one or more SDFs of interest (e.g., SDFs subject to ADR reporting). The PCF may obtain information from a UDR or a UDM to generate the PCC rules. The SMF may also obtain information related to expected WTRU behaviors from the UDR or UDM directly (e.g., after the SMF receives the PCC rules that may include ADR reporting support and is trigged to obtain the expected WTRU behavior information as a result). The expected WTRU behavior information received by the SMF may include an expected WTRU moving trajectory, a WTRU stationary indication, etc.

At 2 of FIG. 3, the SMF may include information such as expected WTRU mobility and/or an expected WTRU moving trajectory in a QoS profile to be sent to a RAN node. The SMF may determine ADR estimate and reporting parameters, and may send these parameters to the RAN node and a UPF, as described herein.

At 3 of FIG. 3, the SMF may send the QoS profile to the RAN and/or one or more N4 rules to the UPF (e.g., as illustrated by FIG. 2).

At 4 and 5 of FIG. 3, the RAN may determine an ADR estimate for a QoS flow or an SDF of interest that may be associated with the WTRU for whom the expected behavior information is obtained. The RAN node may use the stationary indication related to the WTRU to determine the duration within which the RAN can maintain or satisfy the estimated ADR. For example, if the WTRU is stationary, the RAN may determine that the ADR estimate may be promised or satisfied by the RAN node for a duration T1 (e.g., T1=1 minute).

If the WTRU is expected to be mobile based on the stationary indication, the RAN node may determine that the duration T2 within which it can satisfy or promise the available data rate may be shorter than T1. For example, RAN may only be able to promise the ADR for T2=30 seconds since the WTRU may be served by another RAN node soon (e.g., since the WTRU is mobile).

If the RAN has information about a WTRU moving speed, the RAN may determine that the duration within which it can promise or satisfy the ADR may be longer or shorter than T1 or T2, depending on how fast the WTRU is moving.

The indication of the WTRU mobility and the expected trajectory may be dependent on the WTRU location and/or time of the day. As such, different RAN nodes may receive common WTRU mobility information or different WTRU mobility information that may depend on the WTRU location and/or time of the day. For example, if the RAN serves the WTRU in the area that a user of the WTRU resides, the WTRU may be expected to stay for longer time in the same location and thus may be considered stationary in that location.

At 6 and 7 of FIG. 3, the RAN may send an ADR estimate with an associated duration value (e.g., refined based on the WTRU mobility information described herein) to the AF, for example, via the UPF. The RAN node may use an indication that the WTRU may be moving and/or the WTRU's expected moving trajectory to determine possible target RAN node(s) that may serve the WTRU after a certain duration.

Since the available data rate for an SDF or a QoS flow may be related to a GBR QoS flow, with resources such as an GFBR guaranteed, and since a target RAN node may not have agreed to admit the QoS flow for a PDU session of interest (e.g., since a handover has not taken place), the target RAN may not be able to indicate whether it may support an ADR within the GBR QoS flow.

In the event of a WTRU handover to a new RAN node, the source RAN node may include, along with QoS flow related information, an indication that ADR measurement and reporting may be configured for a QoS flow of interest (e.g., if the target RAN node supports it). The source RAN node may provide the target RAN node with the most recent ADR estimate determined by the source RAN node, and/or a duration value (e.g., T1) within which the source RAN node may have been able to satisfy the ADR if the WTRU had been stationary. The source RAN node may include the duration (e.g., T2) within which it can promise or satisfy the ADR as a result of the WTRU's handover, which may be shorter than T1.

The target RAN node may use the information provided by the source RAN node to continue reporting ADR estimates. The target RAN node may update the duration (e.g., T2) provided by the source RAN node and inform an AF that a duration larger than T2 (e.g., T1) may be supported and/or that the duration may be extended.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A network device network device associated with a wireless communication network, the network device comprising:
a processor configured to:
determine an available data rate (ADR) associated with a data flow and a time period during which the ADR can be accommodated by the wireless communication network, wherein the ADR indicates a data rate capability of the wireless communication network with respect to transmission or reception of the data flow;
determine, based at least on the ADR and the time period, whether to report the ADR to at least one other device; and
based on a determination to report the ADR:
generate a report, wherein the report indicates at least one of the ADR or the time period; and
transmit the report to the at least one other device.

2. The network device of claim 1, wherein the ADR is greater than a guaranteed flow bit rate associated with the data flow and less than a maximum flow bit rate associated with the data flow.

3. The network device of claim 1, wherein the processor is further configured to receive a request for the report.

4. The network device of claim 1, wherein the processor is configured to determine whether to report the ADR based further on a first threshold value, and wherein the determination to report the ADR is made by the processor based at least on a condition that the ADR is above the first threshold value.

5. The network device of claim 4, wherein the processor is configured to determine whether to report the ADR based further on a second threshold value, and wherein the determination to report the ADR is made by the processor based on a further condition that a length of the time period exceeds the second threshold value.

6. The network device of claim 5, wherein the processor is further configured to receive ADR reporting assistance information that indicates at least one of the first threshold value or the second threshold value.

7. The network device of claim 6, wherein the ADR reporting assistance information further indicates a granularity for reporting the ADR.

8. The network device of claim 6, wherein the ADR reporting assistance information is received from a session management function (SMF) of the wireless communication network.

9. The network device of claim 8, wherein the ADR reporting assistance information is included in a quality of service (QoS) profile.

10. The network device of claim 1, wherein the ADR is associated with a quality of service flow or a service data flow.

11. The network device of claim 1, wherein the network device is a base station of the wireless communication network, and wherein the processor is further configured to determine at least one of the ADR or the time period based on mobility information of a wireless transmit/receive unit (WTRU) associated with the data flow.

12. The network device of claim 11, wherein the mobility information indicates an expected mobile or stationary state of the WTRU.

13. The network device of claim 1, wherein the network device is a user plane function (UPF) of the wireless communication network.

14. The network device of claim 13, wherein the processor is further configured to determine a validity of the report based on a mobility event detected by the network device, the processor further configured to send an indication of the validity of the report to the at least one other device.

15. A method implemented by a network device network device associated with a wireless communication network, the method comprising:
determining an available data rate (ADR) associated with a data flow and a time period during which the ADR can be accommodated by the wireless communication network, wherein the ADR indicates a data rate capability of the wireless communication network with respect to transmission or reception of the data flow;
determining, based at least on the ADR and the time period, whether to report the ADR to at least one other device; and
based on a determination to report the ADR:
generating a report, wherein the report indicates at least one of the ADR or the time period; and
transmitting the report to the at least one other device.

16. The method of claim 15, wherein the ADR is greater than a guaranteed flow bit rate associated with the data flow and less than a maximum flow bit rate associated with the data flow.

17. The method of claim 15, wherein the determination of whether to report the ADR is based further on a first threshold value, and wherein the determination to report the ADR is based at least on a condition that the ADR is above the first threshold value.

18. The method of claim 17, wherein the determination of whether to report the ADR is based further on a second threshold value, and wherein the determination to report the ADR is based on a further condition that a length of the time period exceeds the second threshold value.

19. The method of claim 18, further comprising receiving ADR reporting assistance information that indicates at least one of the first threshold value or the second threshold value.

20. The method of claim 15, wherein at least one of the ADR or the time period is determined based on mobility information of a wireless transmit/receive unit (WTRU) associated with the data flow.
